(19) United States
(12) Patent Application Publication
(10) Pub. No.: US 2006/0170175 A1
(43) Pub. Date: Aug. 3, 2006

(54) Pivoting shackle plate with angled connection to steering axle

(75) Inventors: David K. Platner, Shelby, MI (US); Tomaz D. Varela, Shelby Township, MI (US); Benjamin R. Reineck, Waterford, MI (US); Xinyu Wen, Shelby Township, MI (US); Kenneth Hooper, Livonia, MI (US); Kou Yang, Goodrich, MI (US); Tjong Lie, Naperville, IL (US); Richard Clisch, Canton, MI (US); James Trotter, Auburn Hills, MI (US); Jonathan S. Rose, Orion, MI (US); Edward Eshelman, Rochester Hills, MI (US); Ragnar Ledesma, Sterling Heights, MI (US); Rajesh Somnay, Troy, MI (US); Nancy Saxon, Oakland Township, MI (US); Felipe Susin, Caxias so Sul (BR)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/046,316

(22) Filed: Jan. 28, 2005

(51) Int. Cl. B60G 9/02

(52) U.S. Cl. 280/124.106; 280/124.116

(57) ABSTRACT

A suspension for a steering axle includes two links extending from the axle laterally inwardly to be attached to a lateral shackle plate. The lateral shackle plate is pivotally attached to the vehicle frame. The links may be two separate members, or may be a single V-shaped member. The links operate to transfer lateral loads between the two sides of a vehicle receiving the suspension.

### BACKGROUND OF THE INVENTION

This invention relates to a suspension for a heavy vehicle steering axle in which the axle is in part connected to a vehicle frame by laterally inwardly extending elements, which are mounted to a pivoting shackle plate extending across a lateral extent of the vehicle.

Suspensions for heavy vehicles typically include arms, which are pivotally connected to a vehicle frame and fixed to the axle. Air springs or other biasing elements are mounted onto the axle and limit the pivoting movement of the axle about the pivot points.

Within this broad description, there are many different arrangements to provide various functions. Suspensions must be able to resist loads in a number of directions, and each of the different arrangements addresses these loads in a different manner and to different effect.

One known suspension for a heavy vehicle includes a V-shaped link extending away from the axle in a first direction and pivotally mounted to a fixed portion of a vehicle frame. Suspension arms extend from the axle in an opposed direction and are pivotally mounted to a plate, which is in turn pivotally mounted on the vehicle frame. The V-shaped link provides resistance to lateral forces through the fixed connection to the vehicle frame. However, since the V-link is pivotally mounted to a fixed portion of the vehicle frame, it is not able to move forwardly and rearwardly in response to forces. The suspension arms and the associated pivoting plates allow this movement.

### SUMMARY OF THE INVENTION

In disclosed embodiments of this invention, a steering axle is provided with a suspension including laterally spaced elements that are connected to a pivoting plate in turn attached to the frame. Suspension arms are also connected between the axle and the frame. The pivoting plate extends across a lateral extent of the vehicle and is pivotally mounted to the vehicle frame. The laterally spaced elements extend laterally inwardly from two spaced locations on the axle. In one embodiment, two separate laterally spaced elements are utilized. In a second embodiment, a single V-shaped link provides both laterally spaced elements.

By mounting the laterally spaced elements to a pivoting plate, the present invention allows the laterally spaced elements to move in response to forward and rearward forces through the pivoting plate.

These and other features of the present invention can be best understood from the following specification and drawings, the following of which is a brief description.

### BRIEF DESCRIPTION OF THE DRAWINGS

FIG. 1A shows a first embodiment of the present invention.

FIG. 1B is a perspective view of the FIG. 1A embodiment.

FIG. 2 is a detail of the FIG. 1A embodiment.

FIG. 3 shows a second embodiment of the present invention.

### DETAILED DESCRIPTION OF THE PREFERRED EMBODIMENT

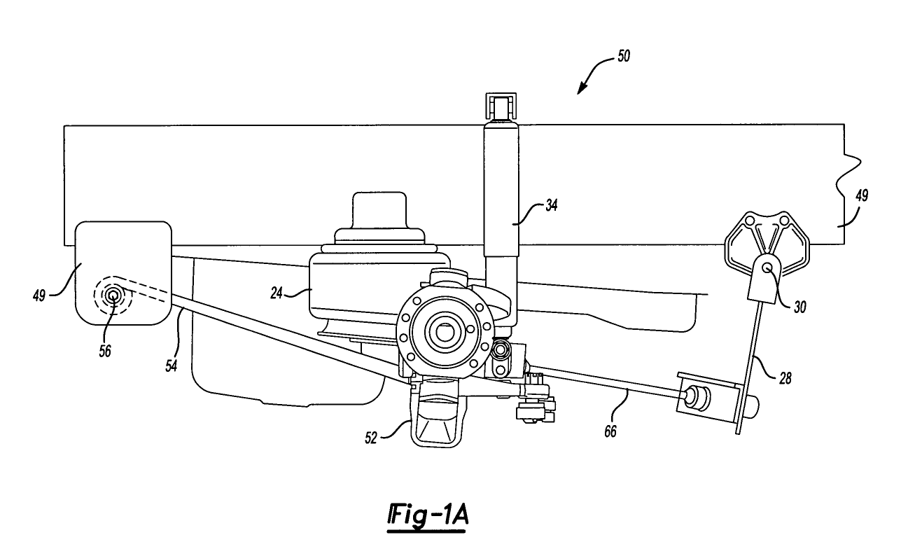

FIG. 1A is a side view of an inventive suspension 50. An axle 52 is mounted to a vehicle frame 49 through the suspension 50. As shown, springs 24 and shock absorbers 34 are mounted between the frame 49 and axle 52, as known. Suspension arms 54 extend from a fixed mount on the axle 52 to a pivotal connection 56 on a fixed portion of vehicle frame 49. In this embodiment, suspension arms 54 are trailing arms. A pair of laterally extending members 66 (only one shown in FIG. 1A) extend in an opposed direction from the axle 52 and are mounted within a lateral shackle plate 28. The lateral shackle plate 28 is pivotally mounted at 30 to the fixed vehicle frame 49.

As shown in FIG. 1B, the suspension 50 mounts axle 52 through a pair of suspension arms 54, which are pivotally mounted at 56 to vehicle frame 49. A steering linkage 60 is connected to turn wheels associated with the axle 52, as known. Plates 62 receive bushing mounts 64 from two laterally inwardly extending members 66. The laterally inwardly extending members 66, or links, are mounted in bushings 70 within a V-plate 68 on the lateral shackle plate 28. V-plate 68 is fixed to lateral shackle plate 28. As shown, lateral shackle plate 28 extends laterally between sides of vehicle frame 49 and is pivotally attached at 30 to the frame 49.

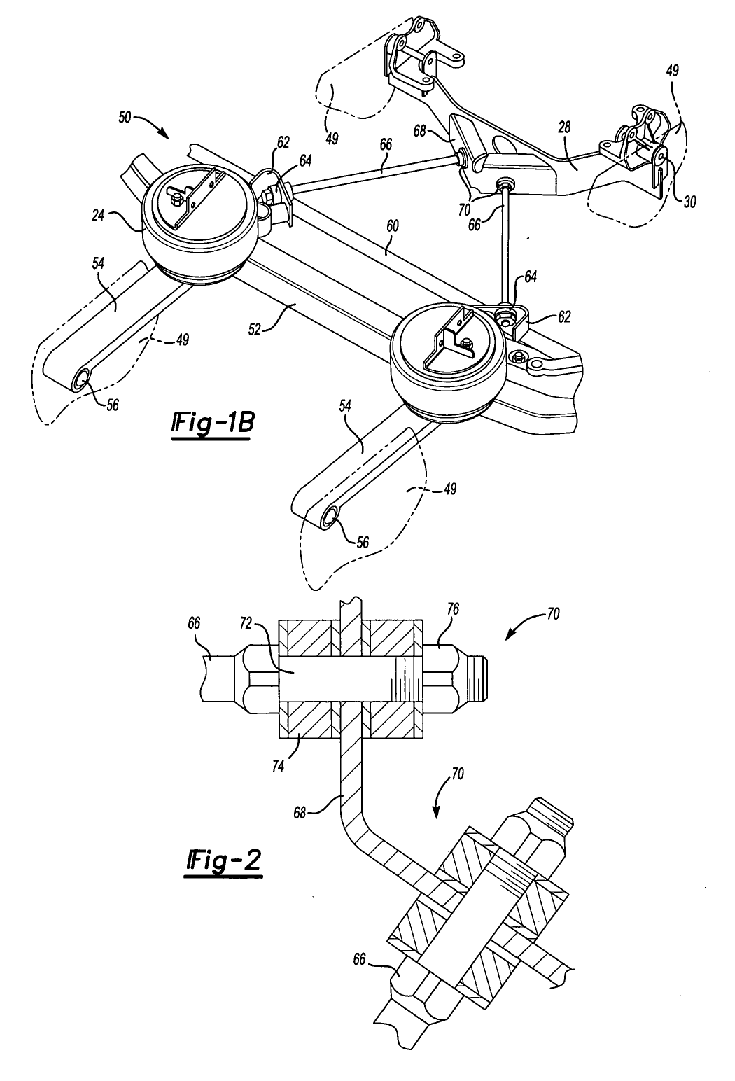

As shown in FIG. 2, the bushings 70 (bushings 64 would be similar) are received within the V-plate 68. A bolt 72 extends to a nut 76. Resilient bushing members 74 are positioned within the bushing 70. Thus, the bolt 72, and hence the laterally inwardly extending members 66, have some freedom of movement relative to the V-plate 68 through the resilient bushing members 74.

A lateral force on the vehicle will pass through the laterally inwardly extending member 66 on that side and be transferred into the V-plate 68. At the same time, a force from the laterally inwardly extending member 66 on the other side would be pulling on the V-plate 68. These combined forces would result in a generally lateral force on the lateral shackle plate 28. The force would generally be transferred into the frame. Since the lateral shackle plate 28 extends across the vehicle, it does provide some stiffness and resistance to this lateral force, as well as providing increased stiffness between the frame rails.

As can also be appreciated from FIGS. 1A and 1B taken in combination, an extended apex defined by the laterally inwardly extending member 66, would be close to being in line with a roll axis for the assembly.

At the same time, since the lateral shackle plate 28 pivots, it will allow laterally inwardly extending members 66 to respond to fore and aft forces, and would also not increase resistance to a roll force of the suspension.

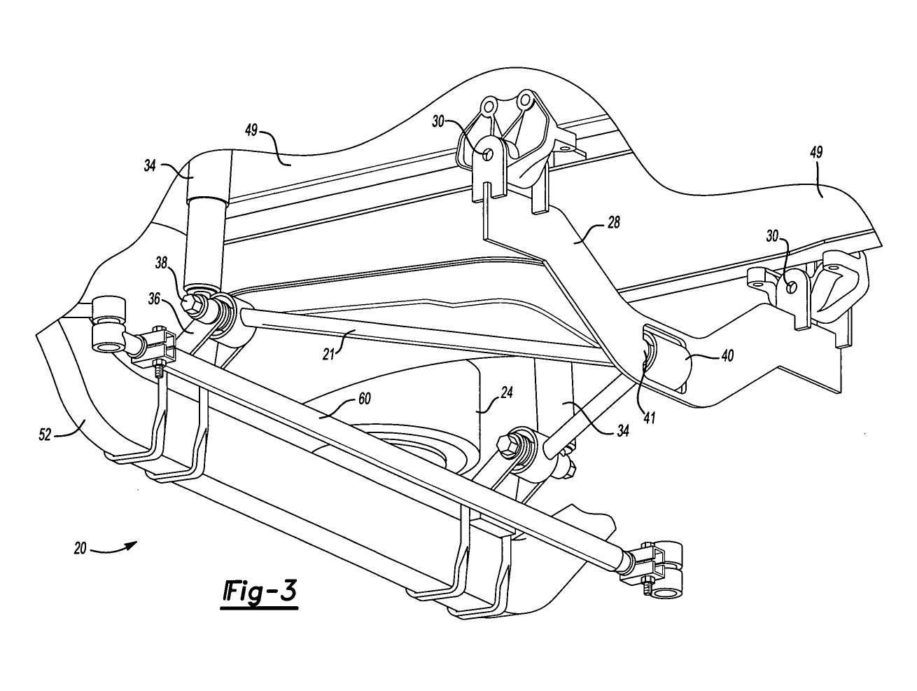

FIG. 3 shows another embodiment 20. In this embodiment, the two separate laterally inwardly extending members 66 are replaced by a single link, or V-shaped element 21. V-shaped element 21 has ends pivotally attached at pivot connections 38 to brackets 36. Brackets 36 further each pivotally receive a shock absorber 34. An apex 40 of the V-shaped element 21 is pivotally received at pivot point 41 within the lateral shackle plate 28. In the FIG. 3 embodiment, since the lateral shackle plate 28 can pivot, the lateral forces can be resisted, while at the same time, the lateral shackle plate 28 allows adjustment to fore and aft forces and does not increase roll stiffness. In a disclosed embodiment, spherical bushings are utilized at pivot points 38 and 41.

Although preferred embodiments of this invention has been disclosed, a worker of ordinary skill in this art would recognize that certain modifications would come within the scope of this invention. For that reason, the following claims should be studied to determine the true scope and content of this invention.

What is claimed is:

1. An axle and suspension assembly comprising:
an axle extending between lateral ends;
suspension elements extending from said axle to be pivotally attached to a vehicle frame; and
a linkage including two laterally spaced members attached to said axle at two laterally outwardly spaced positions on said axle to be attached to a shackle plate, said shackle plate for being pivotally mounted to a frame of a vehicle.

2. The assembly as set forth in claim 1, wherein said two laterally spaced members are formed by two links that are separately attached to said shackle plate.

3. The assembly as set forth in claim 2, wherein a V-plate is secured to said shackle plate and receives said two links.

4. The assembly as set forth in claim 2, wherein said two links are each received within resilient bushings at an end associated with said axle, and at an end associated with said shackle plate.

5. The assembly as set forth in claim 1, wherein said two laterally spaced members are provided by a single V-shaped link.

6. The assembly as set forth in claim 5, wherein an apex of said single V-shaped link is pivotally received within said shackle plate.

7. The assembly as set forth in claim 6, wherein ends of said V-shaped link spaced from said apex are pivotally mounted on said axle at pivot points.

8. The assembly as set forth in claim 7, wherein the pivot points between said axle and said ends also pivotally receive a shock absorber.

9. The assembly as set forth in claim 1, wherein said axle is provided with a steering linkage for steering wheels associated with said axle.

10. A vehicle comprising:
a vehicle frame;
an axle extending between lateral ends;
suspension elements extending in one direction from said axle and pivotally attached to the vehicle frame; and
a linkage including two laterally spaced members attached to said axle at two laterally outwardly spaced positions on said axle and extending laterally inwardly and attached to a shackle plate, said shackle plate being pivotally mounted to the vehicle frame.

11. The vehicle as set forth in claim 10, wherein said two laterally spaced members are formed by two links that are separately attached to said shackle plate.

12. The vehicle as set forth in claim 11, wherein a V-plate is secured to said shackle plate and receives said two links.

13. The vehicle as set forth in claim 11, wherein said two links are received within resilient bushings at an end associated with said axle, and at an end associated with said shackle plate.

14. The vehicle as set forth in claim 10, wherein said two laterally spaced members are provided by a single V-shaped link.

15. The vehicle as set forth in claim 14, wherein an apex of said single V-shaped link is pivotally received within said shackle plate.

16. The vehicle as set forth in claim 15, wherein ends of said V-shaped link spaced from said apex are pivotally mounted on said axle at pivot points.

17. The vehicle as set forth in claim 16, wherein pivot points between said axle and said ends also pivotally receive a shock absorber.

18. The vehicle as set forth in claim 10, wherein said suspension elements are pivotally mounted to a fixed portion of the vehicle frame.

19. The vehicle as set forth in claim 10, wherein said axle is provided with a steering linkage for steering wheels associated with said axle
